(19) United States
(12) Patent Application Publication
(10) Pub. No.: US 2013/0251959 A1
(43) Pub. Date: Sep. 26, 2013

(54) HIGH PERFORMANCE BUOYANT THERMAL INSULATING WRAP

(71) Applicants: Majdi Haddad, Peabody, MA (US); Lou Watkins, Stoughton, MA (US)

(72) Inventors: Majdi Haddad, Peabody, MA (US); Lou Watkins, Stoughton, MA (US)

(21) Appl. No.: 13/427,500

(22) Filed: Mar. 22, 2012

(51) Int. Cl. F16L 59/02

(52) U.S. Cl. 428/192; 428/221

(57) ABSTRACT

A length of buoyant, flexible insulating material for lengthwise encasing a length of pipe comprises syntactic foam that includes a thermoset resin binder and microspheres, wherein the syntactic foam encases a plurality of substantially parallel longitudinal fibrous strands. The thermoset resin may comprise an epoxy resin that includes Bisphenol-A, a curing agent, and a flexibilizer.

### BACKGROUND OF THE INVENTION

The invention relates to the field of buoyant thermal insulating materials, and in particular to the field of buoyant thermal insulating materials comprising syntactic foam.

Syntactic foam is known for use in flexible marine risers for offshore oil exploration and gas production. Syntactic foam is a composite material in which hollow structures, such as microspheres are dispersed in a binder. Flexible marine risers used in offshore oil production are wrapped in insulating tape to retain the heat of the hydrocarbons as they are pumped to the surface. The most common form of insulation has been extruded polypropylene containing glass microspheres. The thermoplastic polymer polypropylene has been popular because the extrusion process lends itself to economical mass production.

As offshore oil and gas operations have moved into deeper waters and hotter reservoirs, wellhead conditions have become more severe. For example, they exhibit temperatures approaching 100° C. and pressure of thousands of lbs per square inch. These conditions exceed the capability of thermoplastic, especially resistance to long-term deformation or “creep”.

There is a need for a buoyant thermal insulating material that may be used in deeper waters and hotter reservoirs.

### SUMMARY OF THE INVENTION

Briefly, according to an aspect of the present invention, a length of buoyant, flexible insulating material for lengthwise encasing a length of pipe comprises syntactic foam that includes a thermoset resin binder and microspheres, wherein the thermoset resin binder comprises Bisphenol-A, a curing agent, and a flexibilizer, wherein the syntactic foam encases a plurality of substantially parallel longitudinal fibrous strands. The thermoset resin may be an epoxy resin.

The plurality of substantially parallel longitudinal fibrous strands may comprise cotton, synthetic fibers or aramid fibers such for example KEVLAR® fibers.

The length of buoyant, flexible insulating material may include first axis parallel sidewalls and second axis parallel sidewalls. The first and/or second axis sidewalls may each include segmented surfaces that abut adjacent lengths of buoyant, flexible insulating material.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 is a pictorial illustration of a length of buoyant, flexible insulating material;

FIG. 2 is a cross sectional illustration of the insulating material taken along line 2-2 in FIG. 1;

FIG. 3 is a cross sectional illustration of an alternative embodiment length of buoyant, flexible insulating material.

### DETAILED DESCRIPTION OF THE INVENTION

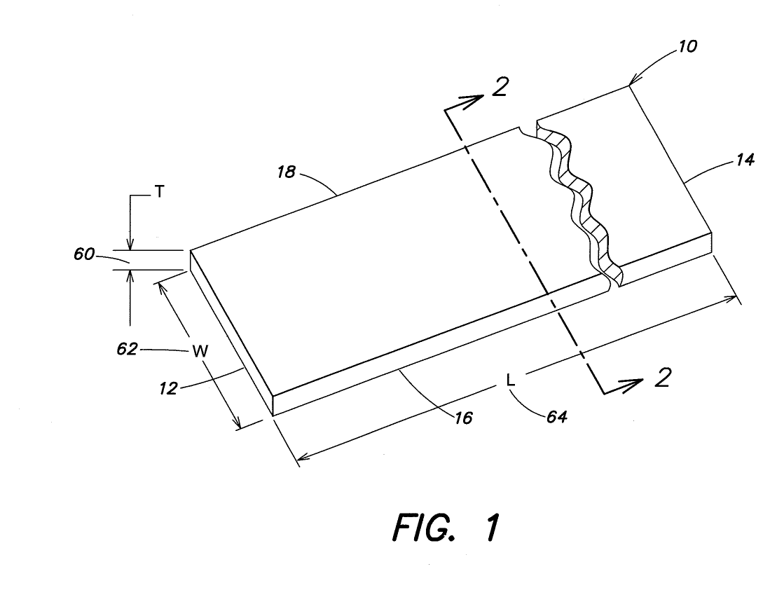

FIG. 1 is a pictorial illustration of a length of buoyant, flexible insulating material 10. The material shall be discussed in the context of an application of being applied (e.g., wrapped, helically wrapped, etc.) around the exterior of a flexible riser flow line (e.g., metallic pipe) for use in deep sea oil operations. However, it is contemplated that the material may be used in applications other than flexible risers, such as for example distributed buoyancy modules.

The material 10 may include first axis parallel sidewalls 12, 14 and second axis parallel sidewalls 16, 18. Adjacent lengths of the buoyant, flexible insulating material 10 may be arranged to abut along on the second axis sidewalls 16, 18, and the abutting lengths may be wrapped around (e.g., helically) the lengthwise exterior of the flow line.

The material 10 provides thermal insulation for sub-sea use, which is relatively strong, light weight, waterproof and contains “packaged air” to reduce the conduction of heat in order to retain the heat of the hydrocarbons flowing in the riser flow line.

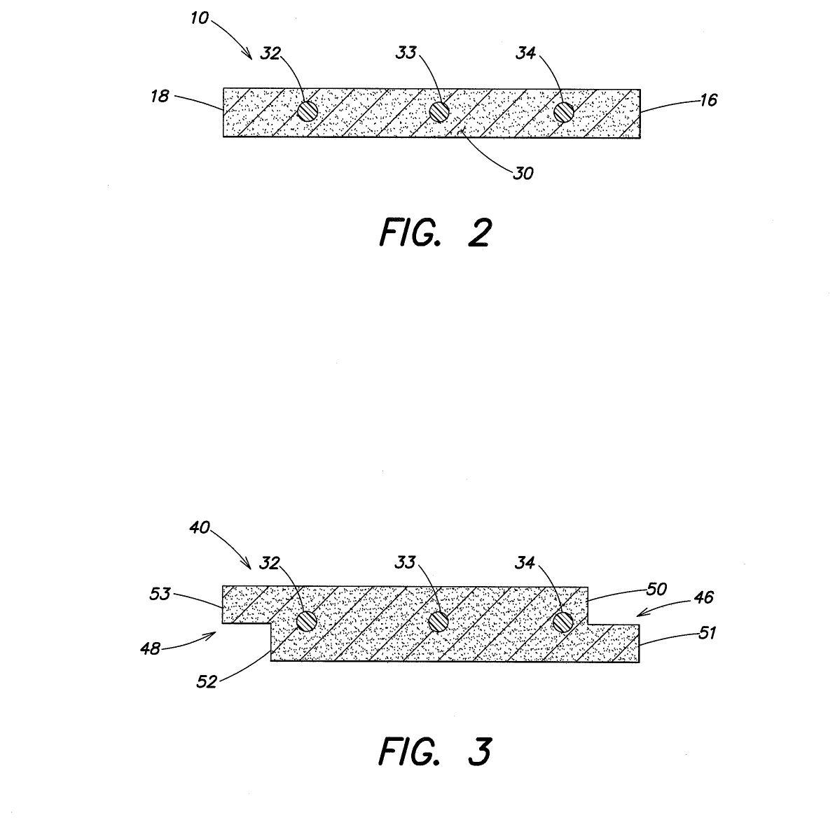

FIG. 2 is a cross sectional illustration of the insulating material 10 taken along line 2-2 in FIG. 1. The insulating material comprises syntactic foam 30 that includes a thermoset resin and microspheres. The thermoset resin may be an epoxy that comprises Bisphenol-A, a curing agent, and a flexibilizer. The syntactic foam 30 encases a plurality of substantially parallel longitudinal fibrous strands, for example 32-34. The fibrous strands may comprise cotton, synthetic fibers or aramid fibers such for example KEVLAR® fibers.

FIG. 3 is a cross sectional illustration of an alternative embodiment insulating material 40. The material 40 includes first axis parallel sidewalls that extend lengthwise and segmented second axis parallel sidewalls 46, 48. The second axis sidewalls 46, 48 may each include segmented surfaces 50-53, respectively. Adjacent lengths of the buoyant, flexible insulating material 40 may be arranged to abut along on the segmented second axis sidewalls 46, 48, and the abutting lengths may be wrapped around (e.g., helically) the lengthwise exterior of the flow line. One of ordinary skill in the art will recognize that the sidewalls may taken on a number of different geometries that facilitates abutting of the wrap around the flow line.

The syntactic foam may include about 20 to 30 parts-by-weight (pbw) of the microspheres, and about 100 pbw of Bisphenol-A epoxy resin, about 20 to 30 pbw of curing agent, and about 15 to 20 pbw of flexibilizer. Other embodiments include other chemistries and other thermoset polymers, such as for example polyester, polyurethane, aliphatic or aromatic urethane acrylate, and silicone.

Referring to FIGS. 1 and 2, the insulating material 10 may have a thickness 38 of about 6 mm, a width 40 of about 100 mm and a length 42 of about 100 mm.

The microspheres may be about 100 microns in diameter (i.e., 0.004″) hollow spheres generally containing a gas which may be atmospheric air, although it may be richer in nitrogen than atmospheric air. The microspheres may have a wall thickness of about one micron. As known, the microspheres are manufactured by blowing glass in a furnace in the presence of blowing agents that cause the glass to bubble.

The material may be used for riser modules, fairings, riser drag reduction devices, distributed buoyancy, ROV floats, et cetera.

Although the present invention has been shown and described with respect to several preferred embodiments thereof, various changes, omissions and additions to the form and detail thereof, may be made therein, without departing from the spirit and scope of the invention.

What is claimed is:

1. A length of buoyant, flexible insulating material for lengthwise encasing a length of pipe, the material comprising:
syntactic foam that includes a thermoset resin binder and microspheres, wherein the syntactic foam encases a plurality of substantially parallel longitudinal fibrous strands.

2. The length of buoyant, flexible insulating material of claim 1, wherein the thermoset resin comprises an epoxy resin that includes Bisphenol-A, a curing agent, and a flexibilizer.

3. The length of buoyant, flexible insulating material of claim 1, wherein the syntactic foam includes about 20 to 30 parts-by-weight (pbw) of the microspheres, and about 100 pbw of Bisphenol-A, about 15 to 20 pbw of a curing agent, and about 15 to 20 pbw of a flexibilizer.

4. The length of buoyant, flexible insulating material of claim 1, wherein the plurality of substantially parallel longitudinal fibrous strands comprises cotton.

5. The length of buoyant, flexible insulating material of claim 1, wherein the plurality of substantially parallel longitudinal fibrous strands comprises synthetic fibers.

6. The length of buoyant, flexible insulating material of claim 5, wherein the plurality of substantially parallel longitudinal fibrous strands comprises aramid fibers.

7. The length of buoyant, flexible insulating material of claim 4, wherein the material includes segmented sidewalls to engage adjacent lengths of buoyant, flexible insulating material.
